(19) United States
(12) Patent Application Publication
(10) Pub. No.: US 2009/0085983 A1
(43) Pub. Date: Apr. 2, 2009

(54) Inkjet printer

(75) Inventors: Johannes M. Simons, Venlo (NL); Erwin Schrijver, Beuningen (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 12/232,984

(22) Filed: Sep. 26, 2008

(30) Foreign Application Priority Data
Sep. 27, 2007 (EP) 07117332.2

(51) Int. Cl. B41J 2/045

(52) U.S. Cl. 347/68

(57) ABSTRACT

An inkjet printer includes a substantially closed ink duct in which ink is situated. The duct is operationally connected to a piezo-element,. The piezo-element is actuated with a number of actuation signals with appropriate waveforms, generated by a first and second signal generator in order to eject ink drops from the duct nozzle. A pressure wave is generated in the duct by an actuation pulse. The pressure wave causes a deformation of a piezo-element, which generates an electric signal as a result. The waveforms of the first and second signal may be different and do not have to be directly subsequent in time.

### CROSS-REFERENCE TO RELATED APPLICATIONS

This application claims priority under 35 U.S.C. §119(a) to Application No. 07117332.2, filed in Europe on Sep. 27, 2007, the entirety of which is expressly incorporated herein by reference.

### BACKGROUND OF THE INVENTION

1. Field of the Invention

The present invention relates to an inkjet printing apparatus, including a print head with a plurality of ink ducts and a plurality of piezo elements. Each of the plurality of piezo elements is operationally coupled to one of the plurality of ink ducts and includes a first electrode and a second electrode.

2. Description of Background Art

Inkjet printers having piezo elements are well known in the background art. In these inkjet printers, each ink duct (also referred to as ink chamber) is operationally connected to a piezo element. By actuating a piezo element, so that it deforms, a volume change is achieved in the ink duct associated with this piezo element. The resulting pressure wave that is produced in the duct, provided it is strong enough, leads to a drop of ink being ejected from the nozzle of the duct. Once the pressure wave has become small enough, the associated piezo element may be re-actuated to eject another ink drop. The actuation of the piezo element is established by a signal over the electrodes generated by a signal generator, sufficiently large to result in an ejection of a drop of ink. In this respect it is advantageous to have a signal generator with a sufficient voltage reach. A reach of 80 V is preferred.

It is generally known from integrated circuit (IC) technology that integrated circuits become more expensive when the voltage reach of such a circuit becomes larger. This is particularly disadvantageous, since the cost growth is not linear with the reach growth, but takes discrete steps of technical adaptations superior to linear growth. The use of just one signal generator implemented as an integrated circuit is therefore expensive, since the voltage reach has to be relatively large.

The use of a switching structure is known from U.S. Pat. No. 5,521,618. In this patent, two switching elements for each piezo element are used to selectively transmit a positive or negative control signal to the piezo element resulting in respectively a positive or negative voltage on the same electrode of the piezo element. A disadvantage of this device is that you need two kinds of voltage sources, a positive and a negative voltage source. This increases the complexity of the structure, thereby undesirably increasing the overall cost.

An inkjet printing apparatus is also known from International Application Publication No. WO 96/14987. In this publication, a print head has a plurality of ink ducts. A piezo element is associated with each ink duct. The piezo element has a first electrode and a second electrode. The piezo elements are arranged in columns and rows, each row connected to a first signal generator and each column connected to a second signal generator. Disadvantageous of this arrangement is that for each signal generator being out of order, a plurality of piezo elements is not useable any more, for example a complete row of piezo elements or a complete column of piezo elements.

### SUMMARY OF THE INVENTION

An object of the present invention is to obviate the above problems and to enlarge the variety of possible signal courses in time when using two signal generators for each piezo element. Each signal generator of the two signal generators applies a signal to another electrode of the piezo element. In this way, a desired voltage reach for a signal is half of the voltage over the piezo element, resulting in the use of less costly signal generators.

According to the present invention, this object can be achieved by an apparatus wherein each of the plurality of first signal generators is connected to the first electrode of one of the plurality of piezo elements, respectively, for applying a first signal to the first electrode, and the second signal generator is connected to the second electrode of each of the plurality of piezo elements for applying a second signal to the second electrode, such that a respective first signal and the second signal establish an actuation signal Uₚₑ over a respective one of the plurality of piezo elements for effectuating an ejection of an ink drop from the respective ink duct in an actuation period.

According to an aspect of the present invention, a first and second signal are applied to a piezo element effectuating an ejection of an ink drop from the ink duct in an actuation period. For ejection of the ink drop, there must be at least one non-zero part during the actuation period in either one or both of the first and second signal. In the sequel the expression ‘signal’ means the course of the voltage during an actuation period, to the extent that there is at least one non-zero part.

It is also possible to select a time interval between the non-zero part of the first signal and the non-zero part of the second signal, in order to create a specific signal course of time of the actuation signal Uₚₑ, resulting in the actuation of the piezo-element. The actuation frequency is determined by the control unit of the printer and is reverse proportional to the length of the actuation time period, which is equal to the length of the first signal, is equal to the length of the second signal and is equal to the length of the actuation signal. The start of the actuation time period is also the start of the first signal and the start of the second signal. The first signal and the second signal are applied to the opposite electrodes of the piezo element. The first signal and second signal can be selected in such a way that the signals are optimized to create a perfect ink drop to be ejected from the nozzle. This optimization can depend on the geometry of the duct, the ink type, the nozzle shape, the actuation frequency during printing, etc. A less perfect ink drop, such as an ink drop with satellite ink drops or an ink drop with a large tail component can be avoided by selecting an appropriate signal. Contamination of the nozzle plate can be avoided in this way. Moreover, research has also shown that a model can be built and applied to the signal generators for tuning on almost all aspects regarding the ejecting of a perfect ink drop.

In an embodiment of the present invention, the first signal generator and the second signal generator each generate unipolar signals, defined as only positive or only negative.

By selecting only positive signals for both generators or only negative signals for both generators, the reach of the voltage per signal generator becomes smaller, which is less costly in IC technology, while the reach over the piezo element is doubled. By applying only positive signals or only negative signals to the opposite electrodes of the piezo element, a bipolar signal over the piezo element is achieved.

In a further embodiment of the present invention, the inkjet apparatus contains a plurality of piezo elements and a plurality of first signal generators. Each of the first signal generators is exclusively connected to one first electrode of each time a piezo element and a second signal generator is connected to a plurality of second electrodes of the said piezo elements.

For example, a first signal is applied to the first electrodes of the piezo elements belonging to the ink ducts that are selected to eject ink and a second signal is applied to all second electrodes of the piezo elements. This has the advantage that the ink in the ducts that do not have to eject ink will be kept in motion by the second signal, preventing undesirable obstructions from arising in those ink ducts. Another advantage is that the circuit of the inkjet printer is reduced in complexity by implementing only one second signal generator for one print head instead of a second signal generator for each piezo element.

In a further embodiment of the present invention, a plurality of piezo elements is present in the print head, where the electrodes of each piezo element are connected to the first and second signal generator and a part of the piezo elements will be actuated, while the complementary part will not be actuated. This can be achieved by letting the first signal generators connected to the electrodes of the piezo elements of the complementary part be in a so-called tri-stated state (high impedance). In this way it is possible to keep the signal on the second electrode as it was before the tri-state of the first signal generator. In this case the actuation signal over a piezo element of this complementary part is 0 Volts. This is also useful if the second electrodes of the piezo elements are connected to one common second signal generator as described in the previous embodiment.

In another embodiment of the present invention, the first signal consists of a non-zero part followed by a zero part, while the second signal consists of a zero part followed by a non-zero part. Normally the non-zero part of the second signal follows the non-zero part of the first signal in time, because the non-zero part of the first signal results in the ejecting of an ink drop, while the non-zero part of the second signal takes care of the timely withdrawal of ink into the ink duct.

In a further embodiment of the present invention, a time interval is created between the non-zero part of the first signal and the non-zero part of the second signal. This is particularly useful when the ink in the duct is still vibrating after the non-zero part of the first signal due to residual pressure fluctuations. To get the ink in a more restful state the non-zero part of the second signal can be issued later on, negating a part or all of these residual pressure fluctuations. In this way the damping is shortened. Knowing this shortening the control unit can be tuned for a higher actuation frequency, since the ejecting of the next ink drop can be earlier in time.

Another advantageous embodiment is that the shapes of the non-zero parts of the first and second signal are selected from arbitrary shapes, for example trapezoidal, triangular or sinus waveform. Moreover, the shape of the non-zero part of the first signal is different from the non-zero part of the second signal. Also, the amplitude of the first and second signal can be different. This is useful since in most cases it is sufficient for the second signal to have smaller amplitude than the first signal or to have a non-zero part which time period is smaller than the time period of the non-zero part of the first signal.

In another embodiment, the sequence of the non-zero part of the first signal and the non-zero part of the second signal is exchanged, so that the non-zero part of the second signal is in time before the non-zero part of the first signal for one actuation. In this way, the non-zero part of the second signal results in a withdrawal of the ink into the ink duct and takes care of an extra key pulse before the non-zero part of the first signal is applied and this sequence of signals results in a larger ink drop. Furthermore, by using the signals in this way a larger control is established on the size of the ink drops.

In another embodiment, the non-zero parts of the first and the second signal are overlapping, so that the actuation signal in the overlapping area is a subtraction of the voltages of the first and second signal. This is applied in the case that the second signal is of the same shape for all second electrodes and that a deviation of the signal on one or more of the first electrodes is desired.

In another embodiment, the first and second signal consist of more than one non-zero parts of the signals from the first signal generator or the second signal generator. The additional non-zero parts of the signals can be tuned in such a way that they are exactly negating the residual pressure fluctuations in the ink duct.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing an inkjet printer;

FIG. 2 is a diagram showing an ink duct assembly and its associated piezo-element;

FIG. 3 is a block diagram showing a circuit containing piezo elements and both signal generators that are suitable to apply a first and a second signal to the piezo element;

FIGS. 4a-4i are diagrams showing possible actuation signals in time, generated by a first and a second signal, where the periods of time of the non-zero parts of the first and second signal are directly sequential in time;

FIGS. 5a-5c are diagrams showing possible potential differences in time, generated by the first and second signal, where a time interval exists between the first period of time of non-zero part of the first signal and the second period of time of the non-zero part of the second signal;

FIGS. 6a-6c are diagrams showing the exchange of the non-zero parts of the first and second signal in time;

FIGS. 6d-6f are diagrams showing an overlapping of the non-zero parts of the first and second signal in time;

FIGS. 6g-6i are diagrams showing more than one consolidated non-zero parts of the first signal and more than one consolidated non-zero parts of the second signal; and

FIGS. 6j-6l are diagrams showing the first signal being tri-stated, the second signal and the resulting actuation signal.

### DETAILED DESCRIPTION OF THE PREFERRED EMBODIMENTS

The present invention will now be described with reference to the accompanying drawings, wherein the same reference numerals have been used to identify the same or similar elements throughout the several views.

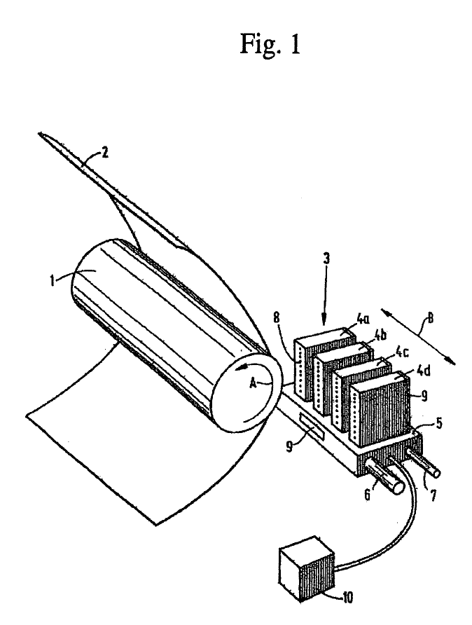

An inkjet printer is shown in FIG. 1. According to this embodiment, the printer comprises a roller 1 used to support a receiving medium 2, such as a sheet of paper or a transparency, and to move it along the carriage 3. The carriage 3 comprises a carrier 5 on which four print heads 4a, 4b, 4c and 4d have been mounted. Each print head contains its own color, in this case cyan (C), magenta (M), yellow (Y) and black (K) respectively. The print heads are heated using heating elements 9, which have been fitted to the rear of each print head 4 and to the carrier 5. The temperature of the print heads is maintained at the correct level by application of central control unit 10 (controller).

The roller 1 may rotate around its own axis as indicated by arrow A. In this manner, the receiving medium may be moved in the sub-scanning direction (often referred to as the X direction) relative to the carrier 5, and therefore also relative to the print heads 4. The carriage 3 may be moved in reciprocation using suitable drive mechanisms (not shown) in a direction indicated by double arrow B, parallel to roller 1. To this end, the carrier 5 is moved across the guide rods 6 and 7. This direction is generally referred to as the main scanning direction or Y direction. In this manner, the receiving medium may be fully scanned by the print heads 4.

According to the embodiment as shown in this figure, each print head 4 comprises a number of internal ink ducts (not shown), each with its own exit opening (nozzle) 8. The nozzles in this embodiment form one row per print head perpendicular to the axis of roller 1 (i.e. the row extends in the sub-scanning direction). According to a practical embodiment of an inkjet printer, the number of ink ducts per print head will be many times greater and the nozzles will be arranged over two or more rows. Each ink duct comprises a piezo element (not shown) that may generate a pressure wave in the ink duct so that an ink drop is ejected from the nozzle of the associated duct in the direction of the receiving medium. The piezo elements may be actuated image-wise via an associated electrical drive circuit (not shown) by application of the central control unit 10. In this manner, an image built up of ink drops may be formed on the receiving medium 2.

If a receiving medium is printed using such a printer where ink drops are ejected from ink ducts, this receiving medium, or a part thereof, is imaginarily split into fixed locations that form a regular field of pixel rows and pixel columns. According to one embodiment, the pixel rows are perpendicular to the pixel columns. The individual locations thus produced may each be provided with one or more ink drops. The number of locations per unit of length in the directions parallel to the pixel rows and pixel columns is called the resolution of the printed image, for example indicated as 400×600 d.p.i. (“dots per inch”). By actuating a row of print head nozzles of the inkjet printer image-wise when it is moved relative to the receiving medium as the carrier 5 moves, an image, or part thereof, built up of ink drops is formed on the receiving medium, or at least in a strip as wide as the length of the nozzle row.

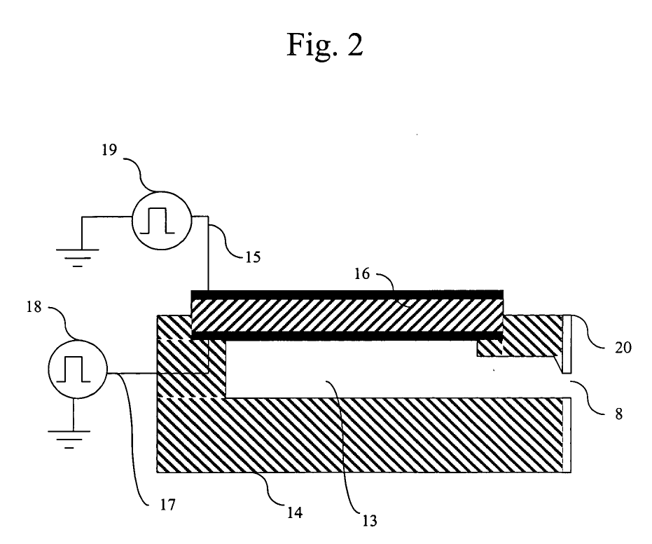

An ink duct 13 is shown in FIG. 2 comprising a piezo element 16. Ink duct 13 is formed by a groove in base plate 14 and is limited at the top mainly by piezo element 16. Ink duct 13 changes into an exit opening 8 at the end, this opening being partly formed by a nozzle plate 20 in which a recess has been made at the level of the duct. When a signal is applied across piezo element 16 by a first signal generator 18 via actuation circuit 17, this piezo element bends in the direction of the duct. This produces a sudden pressure rise in the duct, which in turn generates a pressure wave in the duct. If the pressure wave is strong enough, an ink drop is ejected from exit opening 8. After expiry of the ink drop ejection process, the pressure wave, or a part thereof, is still present in the duct, after which the pressure wave will damp fully over time. This pressure wave, in turn, results in a deformation of piezo element 16.

At the start of the same actuation period, a second signal is sent via second signal generator 19. When the non-zero part of the second signal is applied across piezo element 16, via line 15, this piezo element bends in the opposite direction of the duct. This bending produces a sudden pressure descent in the duct, which in turn generates an opposite pressure wave in the duct. This pressure wave results in a withdrawing of the ink from the exit opening 8. In this way the ink drop can be shaped and the damping of the first pressure wave will be decreased or even eliminated.

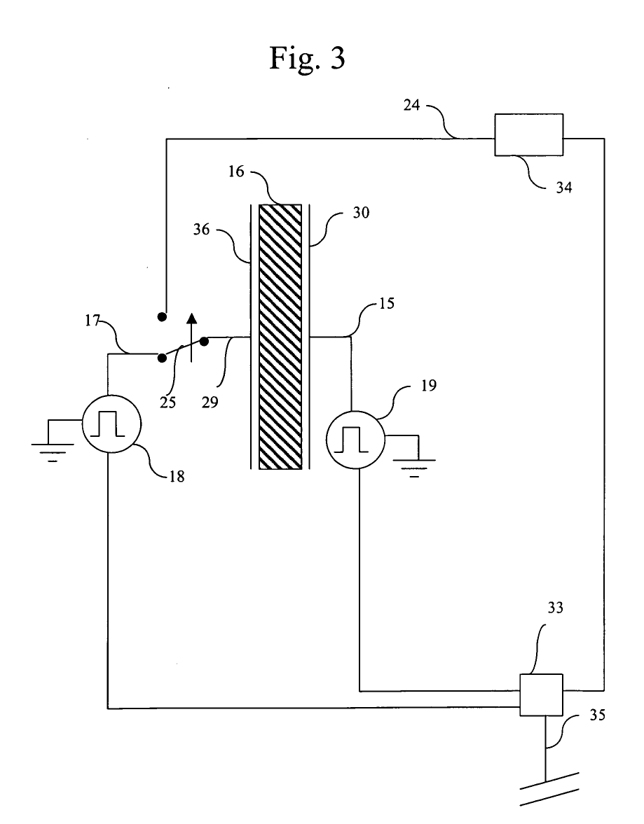

In FIG. 3, a block diagram shows the piezo element 16, the first signal generator 18, the second signal generator 19 and the control unit 33 according to a first embodiment. The actuation by means of signals from the first signal generator 18 and the second signal generator 19 takes place only if the two-way switch 25 is closed between line 17 and line 29. Once signals have been applied across piezo element 16 by signal generator 18 or by signal generator 19, piezo element 16 is in turn deformed resulting in a pressure wave in the ink duct. This deformation is also converted into an electric signal by piezo element 16. After the moment that the amplitude of the second signal becomes fixed, two-way switch 25 is converted to connect line 29 to line 24 and the piezo element 16 is not actuated. On this line 24 a measuring system 34 is located, so that the electric signal generated by the piezo element is received by the measuring system 34 via line 24 and feedback can be passed to the control unit 33. Control unit 33 is connected to the central control unit of the printer (not shown in this figure) via line 35, allowing information to be exchanged with the rest of the printer and/or the outside world.

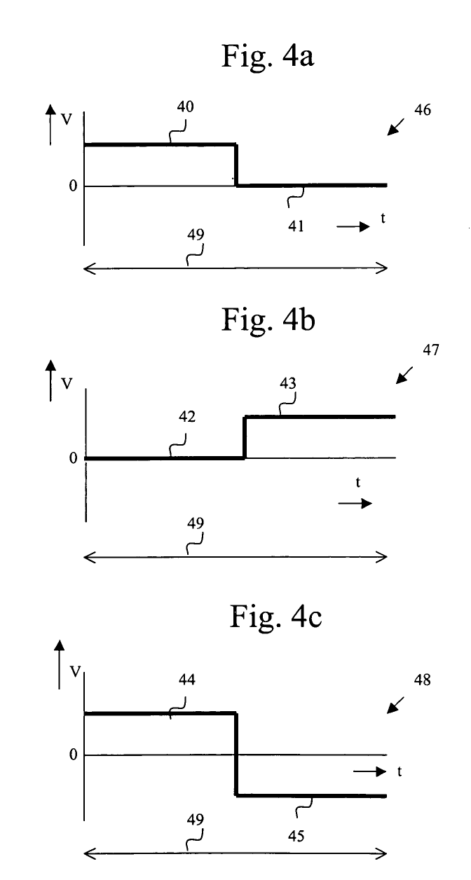

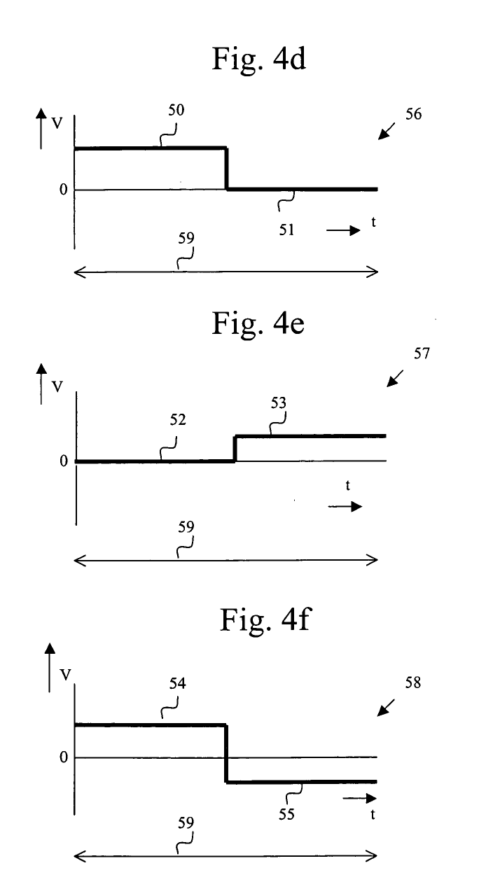

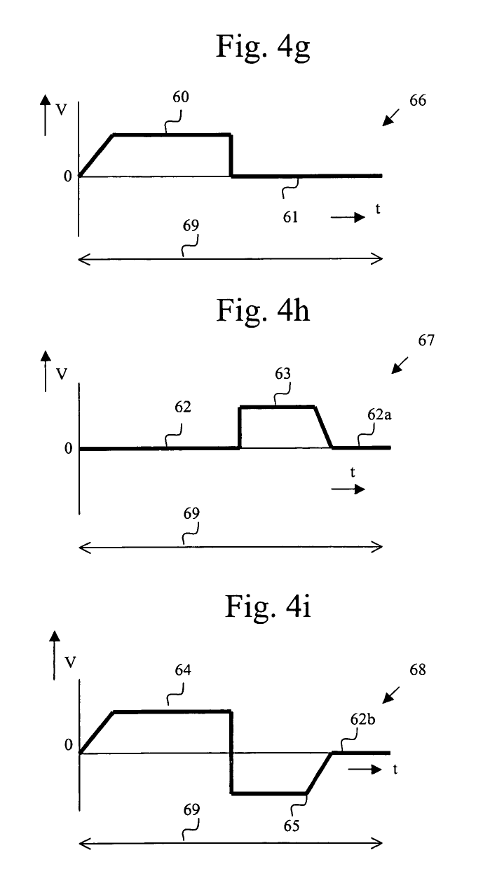

FIGS. 4a-4c show examples of respectively a first signal 46, a second signal 47 and an actuation signal Uₚₑ 48 in time t effectuated by the first signal 46 and the second signal 47.

FIG. 4a shows the first signal 46 consisting of a positive part 40, directly followed by a zero part 41 during an actuation period indicated by the arrow 49. FIG. 4b shows the second signal 47 consisting of a zero part 42, directly followed by a positive part 43 during the same actuation period indicated by arrow 49. FIG. 4c shows the actuation signal Uₚₑ 48 consisting of a positive part 44, directly followed by a negative part 45 during the same actuation period indicated by arrow 49. The amplitude of the first signal 46 and the amplitude of second signal 47 are the same. The shapes of the first and second signal are block-wise. By putting the positive part 43 of the second signal 47 directly after the positive part 40 of the first signal 46 in time, the voltage of the actuation signal Uₚₑ 48 drops from a positive voltage corresponding to the non-zero part of the first signal towards a negative voltage corresponding to the non-zero part of the second signal. In this way, a voltage reach of two times the amplitude of the first signal is realized over the piezo element.

FIGS. 4d-4f show examples of respectively a first signal 56, a second signal 57 and an actuation signal Uₚₑ 58 in time t effectuated by the first signal 56 and the second signal 57. FIG. 4d shows the first signal 56 consisting of a positive part 50, directly followed by a zero part 51 during an actuation period indicated by the arrow 59. FIG. 4e shows the second signal 57 consisting of a zero part 52, directly followed by a positive part 53 during the same actuation period indicated by arrow 59. FIG. 4f shows the actuation signal Uₚₑ 58 consisting of a positive part 54, directly followed by a negative part 55 during the same actuation period indicated by arrow 59. The amplitude of the first signal 56 and the amplitude of second signal 57 are different. In this case, the amplitude of the positive signal part 53 of the second signal 57 is smaller than the amplitude of the positive part 50 of the first signal 56 to prevent a waste of energy, since the ejection of an ink drop does not need the second signal 57 to have an amplitude as large as the amplitude of the first signal 56.

In FIGS. 4g-4i, examples are shown of respectively a first signal 66, a second signal 67 and an actuation signal Uₚₑ 68 in time t effectuated by the first signal 66 and the second signal 67. FIG. 4g shows the first signal 66 consisting of a positive part 60, directly followed by a zero part 61 during an actuation period indicated by the arrow 69. FIG. 4h shows the second signal 67 consisting of a zero part 62, directly followed by a positive part 63, directly followed by a zero part 62a during the same actuation period indicated by arrow 69. FIG. 4i shows the actuation signal Uₚₑ 68 consisting of a positive part 64, directly followed by a negative part 65, directly followed by a zero part 62b during the same actuation period indicated by arrow 69. The shape of the first signal 66 and the shape of second signal 67 are different. In this case, the period of time of the positive signal part 63 of the second signal 67 is smaller than the period of time of the positive signal part 60 of the first signal 66, having the effect of ejection of an ink drop. This will also save energy for each actuation.

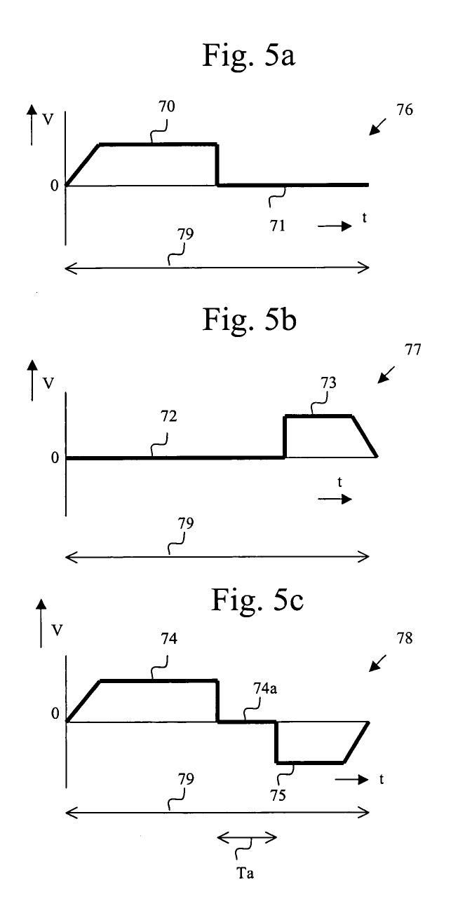

FIGS. 5a-5c show examples of respectively a first signal 76, a second signal 77 and an actuation signal Uₚₑ 78 in time t effectuated by the first signal 76 and the second signal 77. In FIG. 5c, a time interval Ta is present between the end time of a positive signal part 74 of the actuation signal Uₚₑ 78 and the start time of a negative signal part 75 of the actuation signal Uₚₑ 78, containing a zero signal part 74a, due to a time interval between the end time of a positive signal part 70 of the first signal 76 and the start time of a positive signal part 73 of the second signal 77. The FIGS. 5a-5c show the signals for the same actuation period indicated by the arrows 79. As seen before in FIGS. 4a-4i, the amplitudes and the shapes of the first signal 76 and second signal 77 may vary. An effect of the time interval Ta is that the residual pressure fluctuations due to the positive signal part 70 have the possibility to grow numb to get the ink in an appropriate state before the negative signal part 73 is applied during the actuation period indicated by the arrows 79.

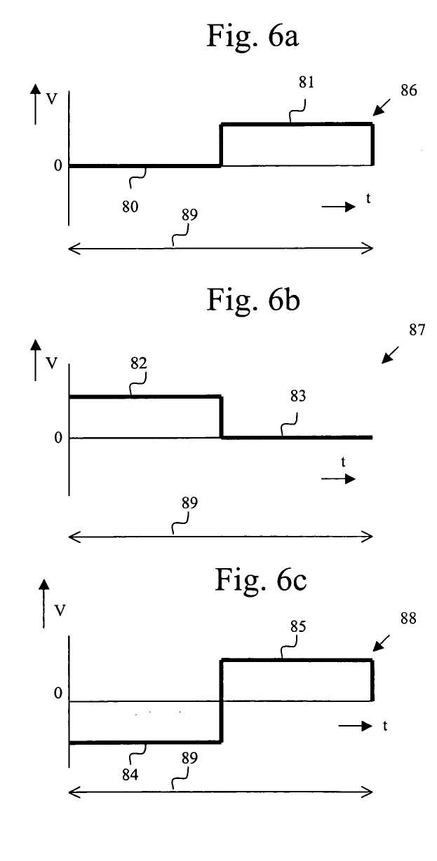

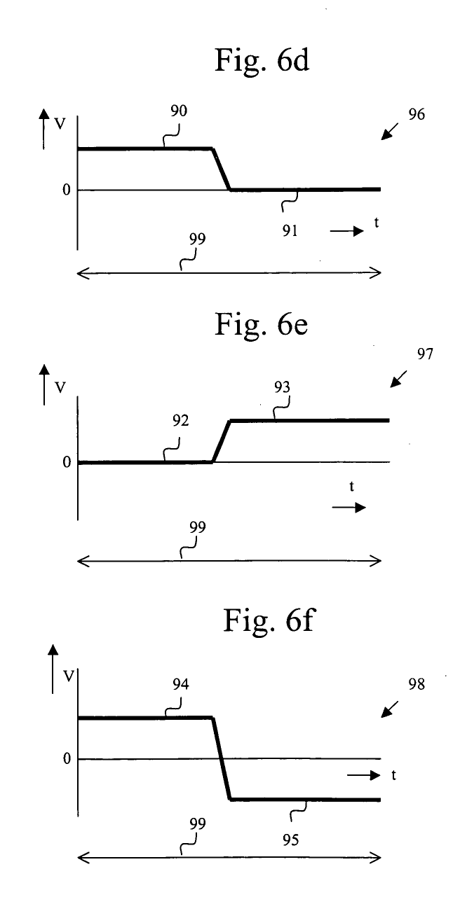

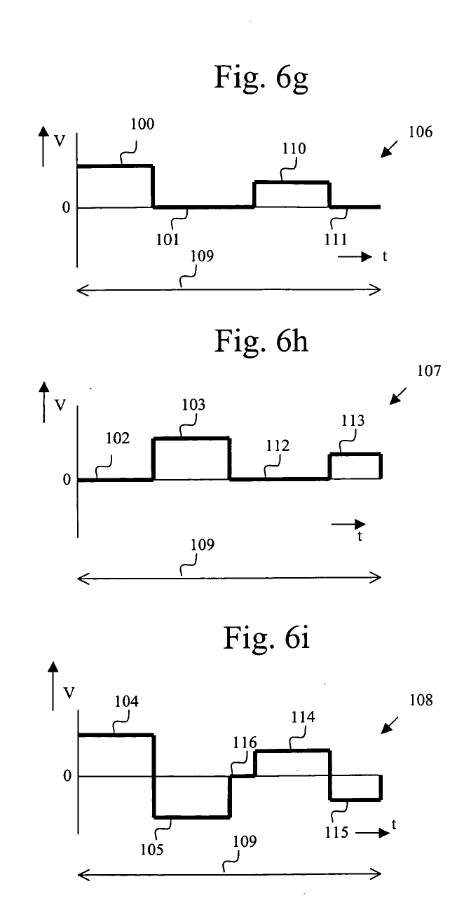

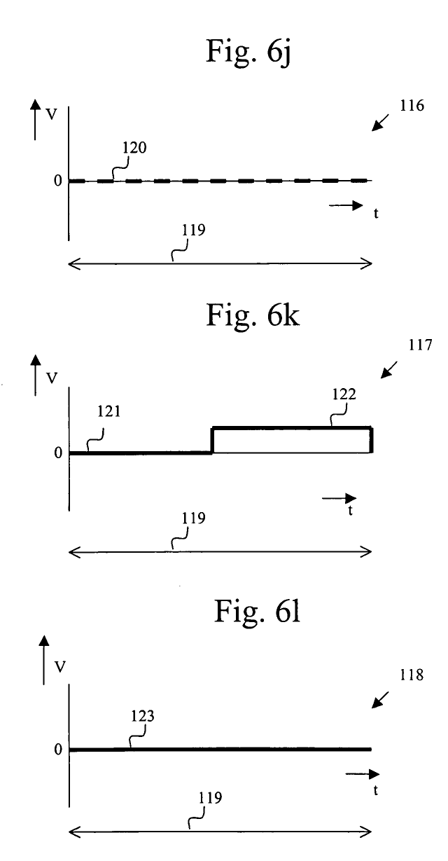

FIG. 6c shows an example of an actuation signal Uₚₑ 88 over a piezo element in time t where a negative signal part 84 and a positive signal part 85 are exchanged in time during an actuation period indicated by the arrow 89. This is achieved by applying to the opposite electrodes of the piezo element, a first signal 86 as shown in FIG. 6a, consisting of a zero signal part 80, followed by a positive signal part 81, and a second signal 87 as shown in FIG. 6b, consisting of a positive signal part 82, followed by a zero signal part 83, applying both signals during the same actuation period indicated by the arrows 89. The advantage of this exchanging is that the size of the ink drop can be regulated. Since the signal part 82 is first in time the ink will be withdrawn just before the signal part 81 is applied. This will result in an extra pulse for the ink ejection and also in a bigger ink drop.

FIG. 6f shows an example of an actuation signal Uₚₑ 98 over a piezo element in time t where a positive signal part 94 and a positive signal part 95 are established during an actuation period indicated by the arrow 99 due to overlapping non-zero parts of a first signal shown in FIG. 6d and a second signal shown in FIG. 6e. This is achieved by applying to the opposite electrodes of the piezo element, the first signal 96, consisting of a positive signal part 90, followed by a zero signal part 91, and the second signal 97, consisting of a zero signal part 92, followed by a positive signal part 93, applying both signals during the same actuation period indicated by the arrows 99. A time overlap exists between signal part 90 and 93, because the start time of the signal part 93 lies in time before the end of signal part 90. In the case that the second signal 97 is of the same shape for all second electrodes, deviations of the first signal 96 on one or more of the first electrodes are easily created by using an overlap of the positive parts of the first signal 96 and second signal 97 for the piezo elements of those electrodes. This can be useful if some ink ducts are polluted or disturbed in any other way and the ink drop should nevertheless be of the same size as the ink drops of other non-disturbed ink ducts.

FIG. 6i shows an example of an actuation signal Uₚₑ 108 in time t established by first signal 106 shown in FIG. 6g and second signal 107 shown in FIG. 6h where both the first signal 106 and the second signal 107 consists of more than one consolidated non-zero signal parts. This is achieved by applying to the opposite electrodes of the piezo element, first signal 106 as shown in FIG. 6g, consisting of positive signal parts 100, 110 and zero signal parts 101, 111, and second signal 107 as shown in FIG. 6h, consisting zero signal parts 102, 112 and positive signal parts 103, 113, applying both signals during the same actuation period indicated by the arrows 109. Positive signal part 104 and negative signal part 105 are followed by zero part 116, positive signal part 114 and negative signal part 115. Additional signal part 115 is just within the predetermined period of time of one actuation as indicated by the arrow 109. The additional signal parts 114 and 115 are used to negate the residual pressure fluctuations in the ink duct. In this way the ink duct comes into a more restful state before the next actuation period starts.

FIG. 6l shows an example of an actuation signal Uₚₑ 118 in time t established by first signal 116 shown in FIG. 6j and second signal 117 consisting of a zero signal part 121 and a non-zero signal part 122 shown in FIG. 6k where the first signal 116 is tri-stated (dashed line 120 in FIG. 6j) during an actuation period indicated with the arrow 119. The achieved actuation signal Uₚₑ 118 has only a zero part 123 and will not result in an ink drop ejection from the ink duct belonging to the piezo element on which electrodes the first signal 116 and second signal 117 are applied.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An inkjet apparatus, comprising:
a print head, the print head comprising:
a plurality of ink ducts;
a plurality of piezo elements, each of the plurality of piezo elements being operationally coupled to one of the plurality of ink ducts and including a first electrode and a second electrode;
a plurality of first signal generators; and
a second signal generator,
wherein each of the plurality of first signal generators is connected to the first electrode of one of the plurality of piezo elements, respectively, for applying a first signal to the first electrode, and the second signal generator is connected to the second electrode of each of the plurality of piezo elements for applying a second signal to the second electrode, such that a respective first signal and the second signal establish an actuation signal over a respective one of the plurality of piezo elements for effectuating an ejection of an ink drop from the respective ink duct in an actuation period.

2. The inkjet apparatus according to claim 1, wherein the first signal and the second signal deform the piezo element, a positive part of the first signal contributes to the deformation of the piezo element in such a way that the ink duct volume decreases, and a positive part of the second signal contributes to the deformation of the piezo element in such a way that the ink duct volume increases.

3. The inkjet apparatus according to claim 1, wherein a first non-zero part of the second signal is directly subsequent in time to a first non-zero part of the first signal.

4. The inkjet apparatus according to claim 1, wherein a first non-zero part of the first signal is directly subsequent in time to a first non-zero part of the second signal.

5. The inkjet apparatus according to claim 1, wherein a time interval greater than zero exists between a first non-zero part of the first signal and a first non-zero part of the second signal.

6. The inkjet apparatus according to claim 1, wherein a non-zero part of the first signal is overlapping in time with a non-zero part of the second signal.

7. The inkjet apparatus according to claim 1, wherein the amplitude of the first signal is different from the amplitude of the second signal.

8. The inkjet apparatus according to claim 1, wherein a shape of the first signal is different from a shape of the second signal.

9. The inkjet apparatus according to claim 1, wherein a non-zero part of the first signal and a non-zero part of the second signal are followed by one or more non-zero signal parts from the first signal generator or the second signal generator or both signal generators, all said non-zero parts being applied within the actuation period.
